(19) United States
(12) Patent Application Publication
(10) Pub. No.: US 2004/0117043 A1
(43) Pub. Date: Jun. 17, 2004

(54) Optimized calibration data based methods for parallel digital feedback, and digital automation controls

(75) Inventor: Igor V. Touzov, Cary, NC (US)

Correspondence Address: IGOR V TOUZOV, 311 CASTLE HAYNE DRIVE, CARY, NC, 27519, US

(73) Assignee: Igor V Touzov, Cary, NC (US)

(21) Appl. No.: 10/605,074

(22) Filed: Sep. 6, 2003

Related U.S. Application Data
(60) Provisional application No. 60/408,921, filed on Sep. 7, 2002.

(51) Int. Cl. G05B 13/02

(52) U.S. Cl. 700/53; 700/31

(57) ABSTRACT

A method of building multiple input multiple output (MIMO) digital control for piecewise single way linearizable plant with hysteresis, a method of system identification that achieves predetermined accuracy across complete spectrum of response model and discovers multiple steady states of a MIMO plant, a method of real-time implementation of various optimal control inputs for a MIMO plant suitable for complete operational envelope of said plant across plurality of steady states, an algorithm and apparatus of multithreading control said MIMO plant that implements methods of the invention and satisfies requirements of high-speed control applications.

### CROSS REFERENCE TO RELATED APPLICATIONS

This application claims the benefit of U.S. Provisional Application Ser. No. 60/408,921 filed Sep. 7 2002.

### BACKGROUND OF INVENTION

1. Field of the Invention

The present invention relates generally to design of multiple inputs multiple outputs (MIMO) system's control that allows nearly optimal operation over wide range of system states.

2. Background

Control design techniques used for achieving nearly optimal control solutions (1) are based on knowledge of internals of the system (further referred as a plant). Such knowledge is acquired from analytical models of a plant or training process that assumes no knowledge of the plant's internals (2,3). Both approaches are well known to engineering community and both represent significant milestones on a way of design and implementation of nearly optimal control solution.

Analytical approach represents less challenge since it is based on explicit knowledge of a plant and its possible states. Art of design of control solution in this scenario narrows down to solving model equations to select robust and at the same time efficient solution. Robustness and efficiency contradict each other. Robustness addresses stability of a control solution at variations of model equations, while reducing efficiency of control that make it less optimal.

Training approach experience quick evolution and is in focus of interest of many scientific and engineering schools. This approach assumes no prior knowledge of a plant and plant model is discovered using real-time monitoring of a plant control variables at various control inputs and auxiliary parameters values (4). This approach requires little or no skills from design engineer and tempts to discover allowable domain of a plant states and plant transfer functions. Complexity of this approach is bound to algorithm of such discoveries. Some of such algorithms use fuzzy logic and neural networks to build internal state model of a plant. Main factor in selection of training approach is speed and stability of the model. While allowing model to be easily mutable makes control solution less robust with respect to unexpected disturbances, making solution to too conservative increases length of training process and could skip discovery of volatile system states. Control design engineer's choice is also driven by considerations of solution stability in case of partial plant failure (5). This factor usually rules out analytical approach as incapable of adaptation to significant model changes. Contrary highly mutable modeling algorithms address such events with highest efficiency.

The purpose of the training is to discover a plant's impulse transfer functions. This task usually solved through monitoring of the plant's response on a control input vector. Often these vectors are selected to have shape of Heaviside step function. Downside of this approach emerges from uneven power spectrum of the transfer function. Measurement of noise power spectrum reveals significant variations of S/N ration across desired frequency range. Ideal solution for this problem would be selection of input vector with power spectrum that compensate for described variations. Causality principle prevents such selection due to unknown plant's dynamics. In current state of the art this causes the problem of non uniform model accuracy across operational frequency range. Current Invention addresses this problem.

Another factor that only recently became possible to model analytically is hysteresis. Hysteresis imposes limitations on majority of LTI based models that either obtained analytically or result of real-time plant discovery. This phenomenon also increases complexity of neural network models (6).

Another general aspect of current state of the art that relates to current invention is selection of time-optimal control functions for MIMO plants. This subject was addressed in great details by Timothy D. Tuttle and Warren P. Seering (1). They propose elegant solution for discovery of time-optimal commands for linear systems. Nevertheless suggested solution for this problem remains hard to implement in cases of saturation of controller outputs and it is hardly applicable to cases of dynamic plant's state.

### OTHER PUBLICATIONS

Tuttle et al., Proceedings of the IEEE International Conference on Control Applications, Sep. 15-18, 1996, “Creating Time-Optimal Commands For Systems with Denominator Dynamics”, pp. 385-390.

Proceedings of 1988 American Control Conference, “A Time Delay Controller for Systems with Unknown Dynamics”, pp. 904-911.

M. Tomizuka, T. C. Tsao, and K. K. Chew, “Analysis and Synthesis of Discrete-Time Repetitive Controllers,” ASME Journal of Dynamic Systems, Measurement, and Control, September 1989, vol. 111, No. 3, pp. 353-358.

K. Srinivasan and F. R. Shaw, “Analysis and Design of Repetitive Control Systems Using the Regeneration Spectrium,” ASME Journal of Dynamic Systems, Measurement, and Control, June, 1991, vol. 113, No. 2, pp. 216-222.

L. T. Grujic, “Tracking Versus Stability: Theory,” Proc. 12th IMACS World Congress, Paris, France, Jul. 18-22, 1988, pp. 319-327.

Jagannathan et al, “Identification of a Class of Nonlinear Dynamical Systems Using Multilayer Neural Networks”, 1994 IEEE International Symposium on Intelligent Control, August 1994.

Vidyasagar, M. “Nonlinear Systems Analysis,” Prentice Hall, Inc. Englewood, N.J., 1993.

### BRIEF DESCRIPTION OF DRAWINGS

The present invention will be more readily understood from a detailed description of the preferred embodiments taken in conjunction with following figures.

FIG. 1 is qualitative comparison of spectral composition of a control response and random disturbances and measurement noise.

FIG. 2 is a recursive algorithm of system identification with multiple steady states.

FIG. 3 is a schematic use of the invention as add-on component responsible for validation and refinement of plant's response model.

FIG. 4 is an example of random and systematic approach to discovery of plant's hidden states.

FIG. 5 is an example of constraint's space segmentation.

FIG. 6 is a simplified diagram of two channel MIMO controller.

FIG. 7 is an illustration of optimal transition trajectory for plant's output.

FIG. 8 is illustration of close-loop feedback operation.

FIG. 9 is a block diagram of multithreaded MIMO controller.

FIG. 10 is a block diagram of calibration channel.

FIG. 11 is a block diagram of feedback channel.

FIG. 12 is a block diagram of feed-forward channel.

### DETAILED DESCRIPTION

Common Conversions

A method and apparatus for optimal digital control of various processes and its use as a close-loop feedback and feed-forward system is described. In the following description, numerous implementation details are omitted. It will be apparent, however, to one skilled in the art, that the present invention may be practiced without those specific details. In most instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical, magnetic signals, location, velocity, acceleration of physical body, temperature or thermal waves capable of being measured, stored, transferred, combined, compared, and otherwise manipulated. It has proven convenient at times, principally for reasons of common usage, to refer to these signals as bits, values, elements, symbols, characters, terms, numbers, or the like. On other hand all these quantities referred as responses, results, outputs, or the like when they considered as a physical characteristics that are subject of control.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magneto-optical disks, read-only memories (ROMs), random access memories (RAMs), EPROMs, EEPROMs, magnetic or optical cards, or any type of media suitable for storing electronic instructions, and each coupled to a digital processing device. The algorithms and displays presented herein are not inherently related to any particular computer or other apparatus. Various general-purpose machines may be used with programs in accordance with the teachings herein, or it may prove convenient to construct more specialized apparatus to perform the required method steps. The required structure for a variety of these machines will appear from the description below. In addition, the present invention is not described with reference to any particular programming language. It will be appreciated that a variety of programming languages may be used to implement the teachings of the invention as described herein.

Some portions of the detailed descriptions use terms transfer and domain to represent known mathematical operator that convert entities that represent some physical quantities into different forms. Such transformations do not alter meaning of physical entities while transferring them to different representation domain. It should be borne in mine that it is obvious to one skilled in mathematics and signal processing that there is equivalence between representations of physical entities in different domains. Keeping this in mind to prevent repetitive descriptions of equivalent procedures performed using alternative transforms following detailed description uses Fourier transform only, which in most cases can be replaced by wavelet transform or Z transform or Laplace transform.

### PREFERRED EMBODIMENTS

This invention discloses innovative approach to discovery of impulse response function of MIMO plant with linear time-invariant state's model. This approach benefits higher model accuracy across complete frequency spectrum. Considering plant stimulus vector s(t) that exist in space S=U# Y, where U##ⁿ is space of control inputs and Y##^{m} is space of plant's detectable outputs. The s(t) vector of functions consists of commonly used vector of inputs u(t) for the plant and vector of plants outputs y(t). In assumption of LTI plant u and Y spaces are bound by plant response matrix G₀, so y(t)=g₂ (t)#u(t)(eq. 101), where matrix g₀ (t)##^{m×n} known as impulse response of the plant. This equation can be extended to plants with dynamic state models only with restriction that state of the plant remains steady for complete subspace of u(t) and y(t).

To simplify description of the invention it is assumed that in its current state plant behave as LTI system when space of u(t) and y(t) restricted by small sphere O, where O##^{m+n} and has its center at (u(0),y(0)). In such case inverse relationship between u(t) and y(t) can be solved u(t)=g₁ (t)#y(t)(eq. 102), which represents feed forward term of a controller. Matrix g₁ (t)##^{n×m}.

Plant input vector u(t) consists of n scalar functions. Current control theory considers these functions as independent. This assumption is only a special case of more generic approach that considers cross-correlations between different inputs. Deconvolution matrix g₂ (t) for vector of plant inputs can be found through well-known computational and analytical techniques, so cross dependency of inputs could be defined asu(t)=g₀ (t)#u(t)(eq. 103).

LTI restrictions impose limitation on plant output vector y(t). Cross-dependency of individual outputs defines matrix g₃ (t) that remains invariant for any value of s(t)#O vector. These relationships result in equation y(t)=g₃ (t)#y(t)(eq. 104), which describes plant behavior in absence of control inputs. This set of equation describes extended model of the plant and in combination with eq. 103 describes a system composed of a controller and a plant as a single entity, for convenience it will be referred as an extended plant. Vector r(t)##^{m+n} represents vector of virtual output of an extended plant that is describe by r(t)=g(t)#s(t)(eq. 105), where s(t)=(u(t),y(t))^{T} and

$$g ( t ) = [ \begin{matrix}{g}_{0} & {( I - {g}_{0} )}^{- 1} {g}_{1} \\ {( I - {g}_{3} )}^{- 1} {g}_{2} & {g}_{3}\end{matrix} ]$$

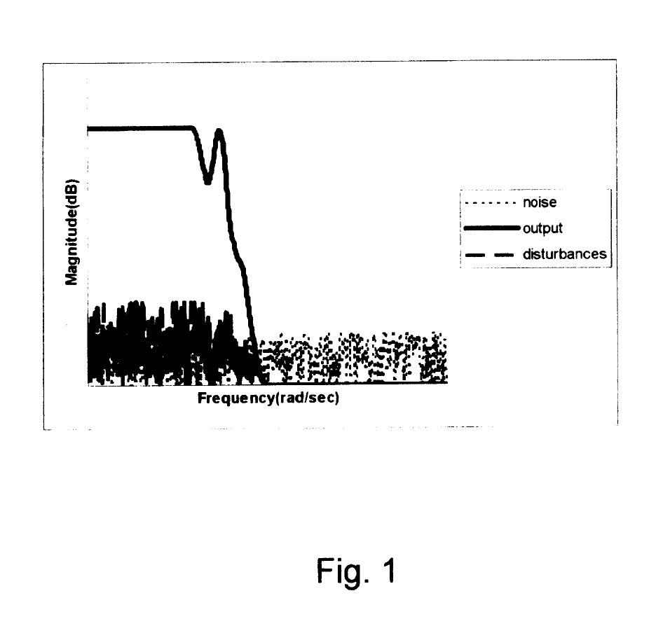

Example of power spectrum of a plant's impulse response compared with power spectrum of measurement noise and disturbances shown on FIG. 1. It is often the case to have Response power spectrum attenuating at higher frequency faster than disturbance spectrum. Measurements noise usually has much wide spectrum than plant's responses to control inputs and disturbances. Such behaviors cause significant variations in signal to noise ration for different bands during collection of the plant response data, which results in less adequate control model.

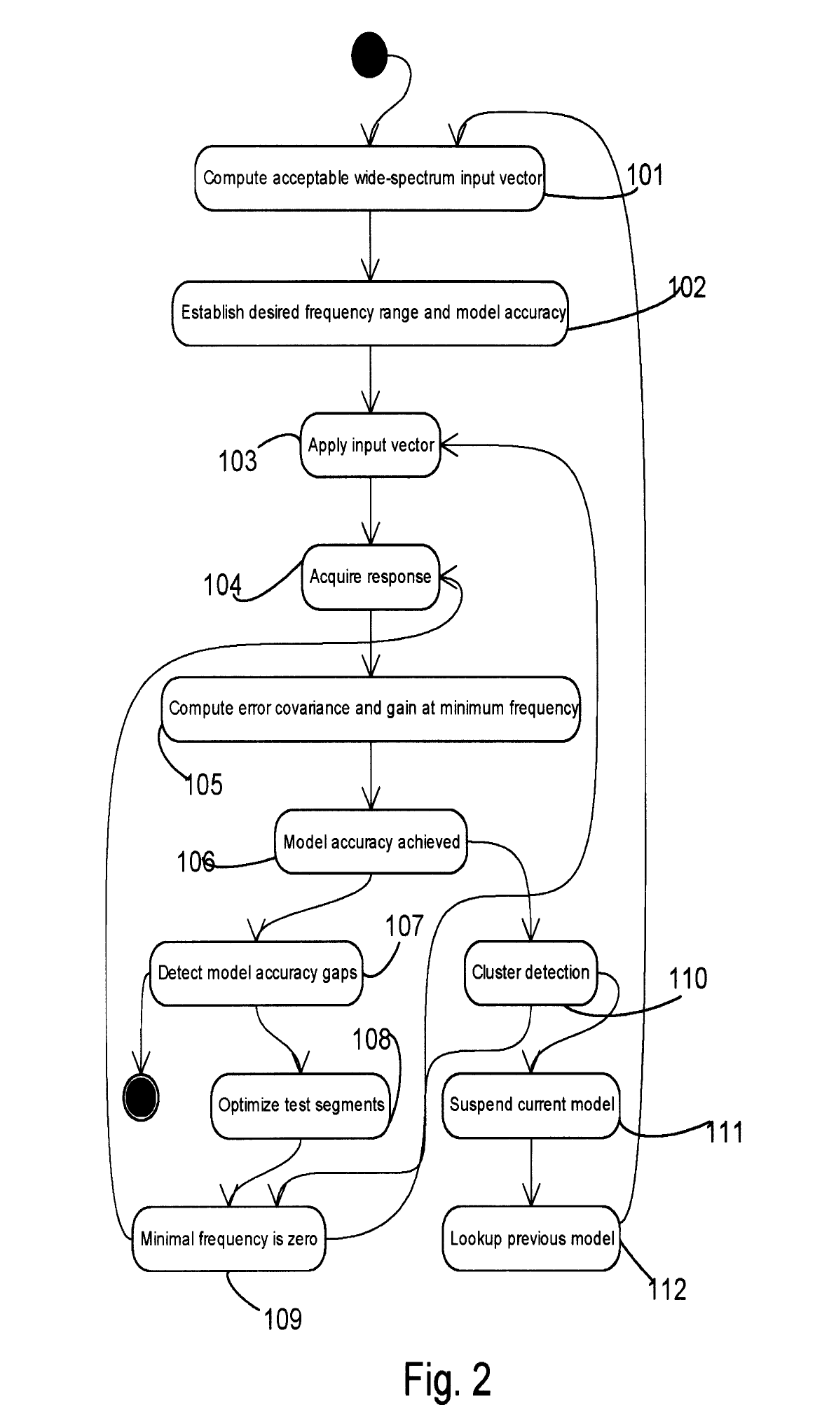

This embodiment discloses method for reconstruction of a plant response that provides predetermined accuracy #(#) across full range of frequencies 102. Block diagram of this method shown on FIG. 2.

1) Stimulus vector for a plant or extended plant is selected based on causality principle so only independent component of the vector receive control inputs. Initial inputs s₀ᵢ(t) are selected as scalar functions with wideband spectrum 101. This selection can be determined based on knowledge of the plant internals or generic set of functions like Heaviside or Ramp or Rectangular can be used as zero approximation.

2) Response vector r(t) is acquired for predefined time period T₀ and its power spectrum is computed 104. The time period for data collection can be determined based on knowledge of the plant dynamics, be dynamically determined using incremental transforms to frequency domain from convergence of static gain vector, or using other approaches known to one experienced in the art. Convergence of zero frequency gains can be estimated using known statistical approaches. For simplicity FIG. 2 shows the use of Kalman filter 105, it is obvious to one experienced in the art that other well known techniques can also be used without limiting the invention.

Increasing T₀ 109 increases accuracy of static gain detection. It also provides accurate estimate for error covariance of model data at low frequency band. Acquisition process is stopped when error of static gain drops below #(0) 106.

3) Low band model analysis 107 finds [#ₖ⁻#ₖ⁺], where error covariance of the model across different time windows exceeds limits defined by #(#) 102. Set of new sₖ (#ₖ⁻#ₖ⁺)(t) is selected for each spectral band. Additional steps are taken to optimize this set and replace each pair of {sₖ (#ₖ⁻,#ₖ⁺)(t) sₖ₊₁ (#ₖ₊₁⁻, #ₖ₊₁⁺)(t)} when total length of execution of Sₖ and Sₖ₊₁ exceeds execution time of a single vector S(#ₖ⁻, #ₖ₊₁⁺)(t) 108.

4) Selected vectors {sₖ} are applied to the plant in order of increasing #ₖ⁻ 103, each vector repeats until the plant model converges at #ₖ⁻ to satisfy #(#k⁻) criteria. During this process plant model is revalidated and invalidated [#ₚ⁻,#ₚ⁺] are excluded when #([#ₚ⁻,#ₚ⁺]) criteria is met. Additional steps are taken to satisfy LTI assumptions for stable plant state. These steps include cluster detection methods 110 for validated segments of the plant model. To keep description simple no discussion on available clustering algorithm will be made. It is obvious to one experienced in the art that multiple algorithms are available and for the goal of this invention the details of those algorithms are not important. As an example simple Student T test can be used to detect clustering by single response component. Method continues on this step to next invalidated spectral band until all bands are validated or clustering is detected.

5) Detection of clustering indicated transition of the plant to a new distinct state gₖ. Such transition contradicts initial assumption on state's stability. When such transition occurs an assumption is made that newly acquired state is also stable for new Oₖ##^{m+n}. Previously constructed plant model g k−1 then stored 111 in completed or incomplete state and new model construction begins 112 following the described steps.

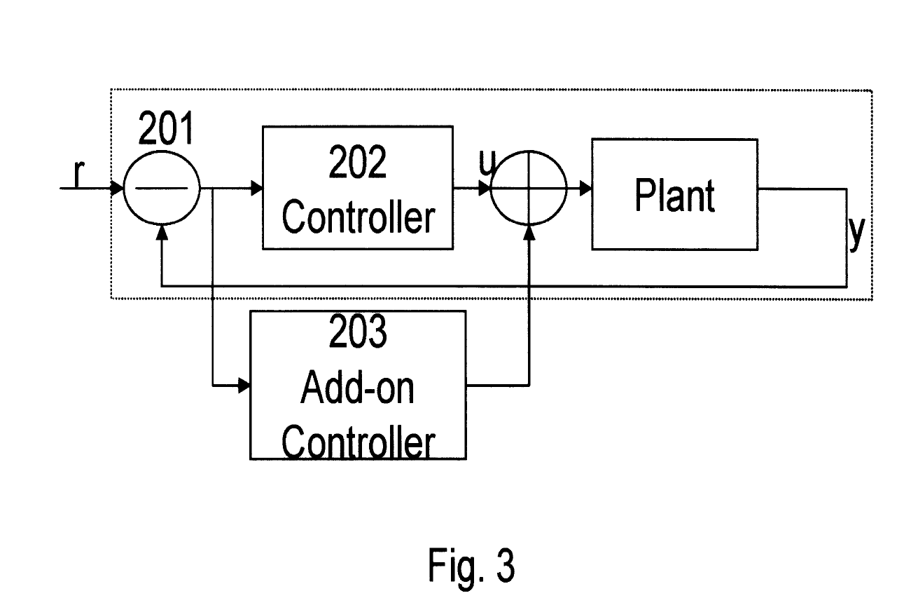

The advantage of method described in current embodiment is its independence from the plant state as well as control inputs. That makes it possible to apply current invention to an extended plant which model needs to be revalidated or tuned. The fact that all stimuli s(t) used in this method are limited by O##^{m+n} allows the method to be applied during operation of the plant. Notice also that all operations of the method are linear, so it can be applied on a real physical plant or a virtual plant constructed from modeling errors of an existing extended plant 201. In this case considering the extended plant with periodic or repetitive states transitions, the method of invention can be modified as shown on FIG. 3 to allow use of control inputs of the plant as a vector of stimuli to perform recursive converging of distinct states models while the plant performs transitions between those states. Referring to FIG. 3 an extended plant 201 includes basic controller 202. Add-on controller 203 operates according to the method of this invention.

Although no robust method exists that is capable of distinction between different steady states of a complex plant this subject remains in constant focus of the art. This invention proposes yet another method for solving this problem. It makes an assumption that no two states share the same stimuli vector s(t). Main restriction of this assumption is an existence of states transitions. It is always possible to select an extended plant in such a way that the assumption will fail. Nevertheless for each extended plant that is controllable or observable the assumption is valid. As an example a plant containing a mix of water and ice will behave as a plant with three distinct stable states (water only, ice only and the mix). Each state behaves in LTI fashion, but transitions between them may not be traced. If this is the case, consider temperature as an output of this plant. The temperature of the mix state could be equal to temperature of any other state, so the assumption mentioned above fails. Addition of pressure or volume or integral of supplied heat as second component to the response vector resolves the problem as the plant becomes observable. An addition of integral of supplied heat as a component of stimuli vector will make the plant controllable and also will make aforementioned assumption valid.

Considering that an extended plant is observable or controllable, current stable state of the plant can be determined by matching current s(t) to one of existing stable state model gₖ using the eq. 105, where r(t)−s(t)#Oₖ. Such detection can be performed a priori or posteriori. A priori state transition performed as a part of dynamic feed forward control, while posteriori in dynamic feedback that may adjust feedback parameters based on current state of the plant.

Yet another embodiment of this invention discloses the use of special control inputs optimized for plants with hysteresis. The nature of a hysteresis described as alternation in plant model behavior due to changes in trajectory directions of state or input variables. This invention proposes the use of control inputs that can be represented as finite functions with all or first k derivatives having the same sign over the length of the input. To perform plant identification using such control inputs various well known methods of system identification can be used with some alterations. The use of method described in previous embodiment will be shown as an example.

Considering control input having n components and each component having u⁺ᵢ(t) or u⁻ᵢ(t) shape. There are 2\hat{ }n input vectors required to perform complete hysteresis identification for each steady state. Advantage of using this approach is simultaneous detection of a hysteresis that could be caused by different derivatives of the input. Each of vectors u(t) has û(t) composed of components with opposite signs. The method described in the first embodiment can operate without changes by using random sequence of proposed inputs. As an example consider template function

ξ(t)=(e^{t}−e⁻¹)Π(t+0.5)+H(t)

that can be scaled by time to satisfy frequency domain requirements of the method, and can be scaled and offset by magnitude to meet actuators constraints. In this case input vector u(t)=#(at+b)B+C, where B is signed vector of amplitudes and C is vector of offsets both selected to satisfy u(t)#O(s).

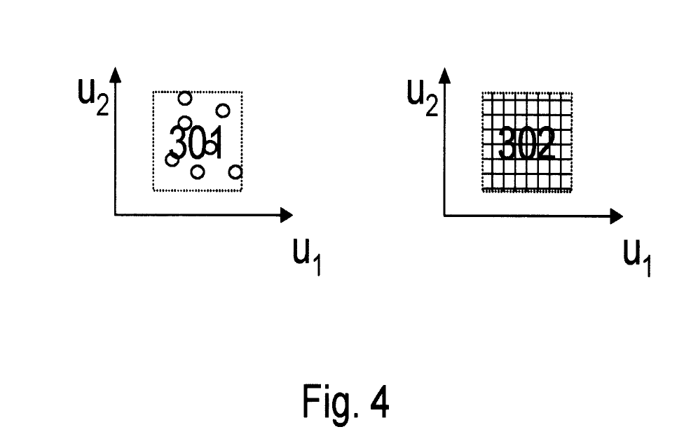

The ultimate goal of the system identification methods is to uncover all hidden states of a plant in shortest time. This task can be accomplished using different strategies, some of which are: random probing of a plant state space, grid, etc. FIG. 4 illustrates these concepts. Random probing 301 arbitrarily select B and C vectors to cover all subspace of allowable actuator values and than builds map between the plant states and input vectors. Grid probing 302 covers all space of inputs with uniform grid and perform sequential or random travel through its nodes. Any selected strategy can use amplitude scaling to probe input space with higher density in regions adjacent to detected state transitions.

Plurality of LTI like models are constructed as a result of described processes and said models compose response model of the plant. This model contains explicit knowledge of the plant response at various states and various vectors of derivatives of the plant inputs. In absence of hysteresis at some state of the plant there will be only one LTI like model regardless of direction of vectors of derivatives of the plant inputs. In presence of hysteresis the same state will have multiple LTI like models where each model is associated with at least one direction of said vector of derivatives of the plant input.

The application of this explicit hysteresis identification may include but is not limited to: generation of optimal control input solution for the plant that provide optimal trajectory of plant output transition; reduction of plant model that excludes hysteretic behavior by enforcement of additional constraints on control inputs.

Yet another embodiment of present invention discloses nearly time-optimal method of feedback control that comprises feed forward elements. Data of MIMO dynamic model of a plant enables one experienced in the art to implement methods for automated discovery of time-optimal or nearly time-optimal inputs for transition of the plant from one steady state to another. For clarity of current disclosure no attempt to describe any of such methods will be made since they are well described in references. It is important to notice that computation of such time-optimal commands for MIMO systems has high cost from digital resources perspective (processor utilization and memory use). Another important aspect to remember is dependency of such input model from various constraints of an extended plant (such as actuators limits, power, fuel rate, etc.). These two factors make it unpractical to implement true time-optimal commands in MIMO systems. Current embodiment describes method that keeps input commands close to time-optimal while permitting real-time implementation on MIMO plants that not necessarily confined to LTI.

Constraints of an extended plant can be represented as a vector of functions cₖ(t,s(t))#C(t)##^{h} for each steady state of a plant. Such form of constrains indicate that they may change with time so volume of space C is dynamic but independent of s(t). This embodiment assumes that rate of C(t) changes is small in comparison with rate of changes in s(t). If such assumption can not be made for some extended plant then it is still possible to use this invention by selecting C=min(c), where operator min( ) takes region of space C that remains steady over characteristic period of s(t) changes. Because of imposed restriction it is safe to approximate C(t) with series of steps as

$$C ( t ) = {\sum }_{i} {D}_{i} H ( t - {t}_{i} )$$

, where Dᵢ is incremental change and H is Heaviside step function, and consider C(t) as a set of constant spaces Cᵢ. For each Cᵢ vector of constraints can be represented as cₖ(s(t)). Important note here is that dimension of constraint vector may change with transitions between steady states of an extended plant.

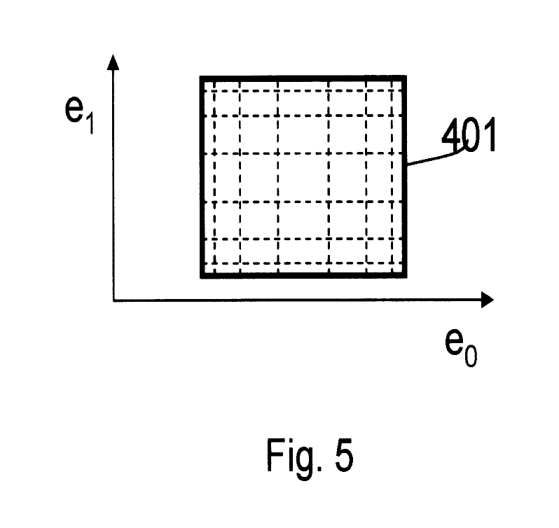

FIG. 5 illustrates an example of constraint space Cᵢ. For simplicity of illustration the space boundaries 401 drawn as a rectangle and number of dimensions equals two. In reality boundary has more sophisticated multidimensional shape. This region of space is divided by plurality of nodes. The nodes can be selected using various desirable strategies. As an example on FIG. 5 the nodes are selected using grid method with linear dependency of the grid size from distance to the boundary and limited maximum and minimum size

d=max(min(^{|r|}/ₑ,dₘₐₓ),dₘᵢₙ)

, where dₘₐₓ and dₘᵢₙ are maximum and minimum grid sizes and r is shortest vector between current node and the boundary. It is obvious to one experienced in the art that choice of particular strategy affects number of nodes, optimality of control solution and other aspects such as allocation of digital resources, but it does not limits the invention. That is why no other examples of node selection strategies will be made here. It is also obvious that different strategies can be used for various steady states of an extended plant.

Set of constraints for each node is well defined so time optimal control inputs can be computed and stored as time series of s values. These recipes are organized in lookup table that indexed by each dimension of the constraint vector. Such indexing schema allows fast real-time access to recipes data. Operation of an extended plant encounter necessities of time optimal control inputs use. Each such event defined by current location of the plant in constraint space, which is known by history of previously issued inputs recipes and current s vector. Second defining factor is static vector of desired state transition (switching distance), which represents only difference between current and desired s vectors.

Control input recipe then retrieved using indexed lookup to nearest node that closer to Cᵢ boundary. Recipe contains a set of solutions. Each solution is defined by maximum switching distance and switching time. This set is ordered or indexed by maximum switching distance. Solution with smallest switching distance that exceeds desired state transition is selected and scaled down to match the transition. Advantage of this invention is that it allows MIMO plant to be controlled during state transitions with desired control accuracy while remaining nearly time-optimal.

Example of Response Spectrum Reconstruction

Following example illustrates the use of method of invention to obtain desired model accuracy across required frequency range. For purpose of illustration it is assumed that matrix g₀ and g₃ are zero matrixes and space S separated on two independent subspaces U and Y. It is also assumed that both spaces have equal dimensions, and plant is LTI.

In accordance with all aforementioned conventions the Invented method description considers equal number of the outputs and the inputs. In general case application or any changes in one of the inputs

$${\vec{u}}_{i} ( t - {t}_{0} ) = {[ \begin{matrix}{u}_{0} ( t - {t}_{i} ) \\ ⋮ \\ {u}_{p} ( t - {t}_{i} )\end{matrix} ]}_{-}$$

will cause changes in some or all outputs of the plant. A set of uₚ(t) functions represents a set of stimuli simultaneously applied to the plant at the moment tᵢ. This process provides valuable information about properties of the plant. The changes in the current state will continue to occur for some period of time after changes in the stimulus have stopped. These changes are acquired from the moment tᵢ of initial change in the input and stored as a vector of response functions

$${\vec{y}}_{i} ( t - {t}_{0} ) = {[ \begin{matrix}{y}_{0} ( t - {t}_{i} ) \\ ⋮ \\ {y}_{k} ( t - {t}_{i} )\end{matrix} ]}_{-}$$

This data will be acquired for all inputs. Collection of vectors uᵢ forms a matrix of stimulus functions:

$$S ( t ) = [ \begin{matrix}{u}_{0}^{0} ( t - {t}_{0} ) & ⋯ & {u}_{0}^{l} ( t - {t}_{l} ) & ⋯ \\ ⋮ & ⋰ & ⋮ & ⋯ \\ {u}_{p}^{0} ( t - {t}_{0} ) & ⋯ & {u}_{p}^{l} ( t - {t}_{l} ) & ⋯\end{matrix} ]$$

Lower index p identified the stimulus component and upper index/identifies a sequence the stimuli have been applied in. Collection of the response

$$R ( t ) = {[ \begin{matrix}{y}_{0}^{0} ( t - {t}_{0} ) & ⋯ & {y}_{0}^{l} ( t - {t}_{l} ) & ⋯ \\ ⋮ & ⋰ & ⋮ & ⋯ \\ {y}_{k}^{0} ( t - {t}_{0} ) & ⋯ & {y}_{k}^{l} ( t - {t}_{l} ) & ⋯\end{matrix} ]}_{-}$$

Lower index k identified the response component of the plant and upper index/identifies a sequence of recording identical to sequence of stimuli application. In order to complete calibration a matrix G of transfer functions of the plant is calculated from the equation:

$$\begin{matrix}R = G * S \\ R ( t ) = [ \begin{matrix}{g}_{0}^{0} ( t ) & ⋯ & {g}_{0}^{p} ( t ) \\ ⋮ & ⋰ & ⋮ \\ {g}_{k}^{0} ( t ) & ⋯ & {g}_{k}^{p} ( t )\end{matrix} ] * S ( t ) \\ ⇕ \\ {y}_{k}^{l} = {\sum }_{p} {g}_{k}^{p} * {s}_{p}^{l}\end{matrix} \qquad ( eq . 201 )$$

This equation is analogous to eq. 101 with only difference that all components of input and output vectors are shown in group form. In the method of Invention it is assumed that the plant repeatedly passes through the same steady state. This example uses step function as a template for components of input vector:

$$S ( t ) = ( \begin{matrix}{a}_{0}^{0} H ( t - {t}_{0} ) & ⋯ & {a}_{0}^{l} H ( t - {t}_{l} ) & ⋯ \\ ⋯ & ⋯ & ⋯ & ⋯ \\ {a}_{p}^{0} H ( t - {t}_{0} ) & ⋯ & {a}_{p}^{l} H ( t - {t}_{l} ) & ⋯ \\ ⋯ & ⋯ & ⋯ & ⋯\end{matrix} )$$

, where a is scalar coefficients and det(S(#))#0. In this case the equation

$$\begin{matrix}F ( R ( t ) ) = F ( G ( t ) ) F ( [ \begin{matrix}{a}_{0}^{0} H ( t - {t}_{0} ) & ⋯ & {a}_{0}^{l} H ( t - {t}_{l} ) & ⋯ \\ ⋮ & ⋰ & ⋮ & ⋯ \\ {a}_{p}^{0} H ( t - {t}_{0} ) & ⋯ & {a}_{p}^{l} H ( t - {t}_{l} ) & ⋯ \\ ⋮ & ⋮ & ⋮ & ⋰\end{matrix} ] ) \\ ⇕ \\ F ( R ( t ) ) = F ( G ( t ) ) \frac{δ ( ω ) - \frac{2 i}{ω}}{2} ( [ \begin{matrix}{a}_{0}^{0} {ⅇ}^{- ⅈ w {t}_{0}} & ⋯ & {a}_{0}^{l} {ⅇ}^{- ⅈ w {t}_{l}} & ⋯ \\ ⋮ & ⋰ & ⋮ & ⋯ \\ {a}_{p}^{0} {ⅇ}^{- ⅈ w {t}_{0}} & ⋯ & {a}_{p}^{l} {ⅇ}^{- ⅈ w {t}_{l}} & ⋯ \\ ⋮ & ⋮ & ⋮ & ⋰\end{matrix} ] ) \\ ⇓ ω \neq 0 \\ ⅈω F ( R ( t ) ) = F ( G ( t ) ) A \\ A = [ \begin{matrix}{a}_{0}^{0} {ⅇ}^{- ⅈ w {t}_{0}} & ⋯ & {a}_{0}^{l} {ⅇ}^{- ⅈ w {t}_{l}} & ⋯ \\ ⋮ & ⋰ & ⋮ & ⋯ \\ {a}_{p}^{0} {ⅇ}^{- ⅈ w {t}_{0}} & ⋯ & {a}_{p}^{l} {ⅇ}^{- ⅈ w {t}_{l}} & ⋯ \\ ⋮ & ⋮ & ⋮ & ⋰\end{matrix} ]\end{matrix}$$

, where # is a frequency # is delta function, H is heaviside step function.

From this equation the matrix G of transfer functions can be obtained as

F⁻¹(iωF(R(t))A⁻¹)=G(t) (eq.202).

In case of non square matrix generalized inverse can be used. In many real-world systems it is often the case that plant response has significant attenuation at some frequency range and their actual value become comparable with external interference and/or noise of measurement equipment. In this case results obtained from equation (eq.202) may become inaccurate. Use of repetitive or periodic input to improve model accuracy was disclosed in the method of Invention. This example demonstrates case periodic input functions

S(t)=S(t−n^{2π}/_{ω0})

(eq.203), where #₀ is period frequency. These stimuli applied to the equation (eq.202) eliminates all components with lower frequencies and increase SNR (signal to noise ratio between response R and noise N-fold where N is number of full periods of S(t) executed during the calibration.

In this case the following equation gives true improved G(t) matrix of transfer functions:

$${\sum }_{h} ( ⅈ ω F ( {R}_{h} ( t ) ) - F ( {G}_{h} ( t ) ) {A}_{h} ) \frac{{B}_{1} ( {ω}_{h} , {ω}_{h + 1} )}{{N}_{h}} = 0$$

, where # is a frequency, #₀=0, Nₕ is number of whole periods used for calibration and B is Boxcar function. Reconstructed of complete response

$$G ( t ) = {\sum }_{h} \frac{{G}_{h}^{\#} ( t )}{{N}_{h}} , \\ where \\ {G}_{h}^{\#} ( t ) = {F}^{- 1} ( F ( {G}_{h} ( t ) ) {A}_{h} \frac{{B}_{1} ( {ω}_{h} , {ω}_{h + 1} )}{{N}_{h}} ) \qquad ( eq . 204 )$$

This equation uses data received from static gain calibration G₀(#) as well as data from calibration with periodic stimuli (eq.203) Gₕ(#). Equation (eq.204) demonstrates the case of calibration that uses any given number of stimuli

$${{p}^{h}}_{l} ( t ) = {\sum }_{n = 0}^{{N}_{h}} Π ( \frac{( t - {t}_{l} ) {ω}_{h}}{π} - 2 n - \frac{1}{2} ) ,$$

where Π is rectangular function

$${S}_{h} ( t ) = ( \begin{matrix}{a}_{0}^{0} {{p}^{h}}_{0} ( t ) & ⋯ & {a}_{0}^{l} {{p}^{h}}_{l} ( t ) & ⋯ \\ … & ⋯ & … & ⋯ \\ {a}_{p}^{0} {{p}^{h}}_{0} ( t ) & ⋯ & {a}_{p}^{l} {{p}^{h}}_{l} ( t ) & ⋯ \\ … & ⋯ & … & ⋯\end{matrix} ) ⇒ \\ {A}_{h} {≡}^{def} ( \begin{matrix}{a}_{0}^{0} {b}_{h}^{0} & … & {a}_{0}^{l} {b}_{h}^{l} & … \\ … & … & … & … \\ {a}_{p}^{0} {b}_{h}^{0} & … & {a}_{p}^{l} {b}_{h}^{l} & … \\ … & … & … & …\end{matrix} ) , where \\ {b}_{h}^{l} ( ω ) = \frac{π}{{ω}_{h}} sin c ( \frac{π ω}{{ω}_{h} 2} ) {\sum }_{n = 0}^{{N}_{h}} exp ( - ⅈ ω ( 2 n + \frac{{t}_{l} {ω}_{h}}{π} + \frac{1}{2} ) ) \qquad ( eq . 205 )$$

Shown example illustrated benefits of plant model incremental reconstruction when accurate responses can not be obtained using traditional techniques. Example used rectangular functions as a stimuli and spectrum merge was done using boxcar functions. This choice was made for simplicity of illustration only and does not restrict the invention to choice of particular shape of the function.

Example of MIMO Feedback Controller with Optimal Control Input

Example illustrates operation of close-loop feedback controller that implements optimized set of control solution to achieve performance improvement. To facilitate subject illustration only necessary details of implementation are shown.

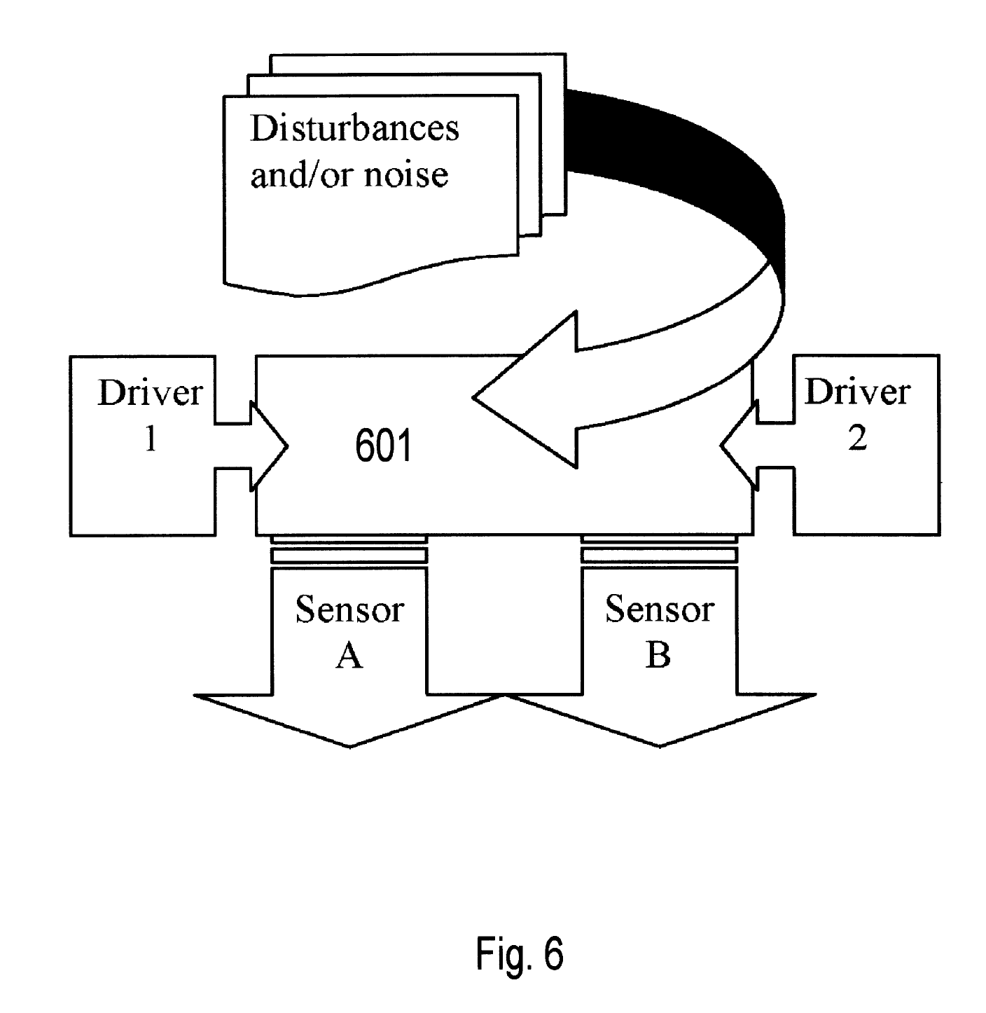

The apparatus referred in this example schematically shown on diagram FIG. 6, for clarity of the demonstration it will have only two drivers that apply control input to the plant 601 and two sensors that characterize plant output or its state. Plant state can be changed so sensor A readings will follow curve R_{A}(t) and readings of sensor B remain constant. To produce this type of results drivers 1 and 2 should output D₁(t) and D₂(t).

Equation (eq. 101) gives exact formula for computing these driver functions:

$$F ( {r}_{k}^{l} ) = {\sum }_{i} F ( {g}_{k}^{i} ) F ( {s}_{i}^{l} ) \\ ⇕ \\ [ \begin{matrix}{\hat{r}}_{0}^{0} ( ω ) & ⋯ & {\hat{r}}_{0}^{l} ( ω ) \\ ⋮ & ⋰ & ⋮ \\ {\hat{r}}_{k}^{0} ( ω ) & ⋯ & {\hat{r}}_{k}^{l} ( ω )\end{matrix} ] = [ \begin{matrix}{\hat{g}}_{0}^{0} ( ω ) & ⋯ & {\hat{g}}_{0}^{i} ( ω ) \\ ⋮ & ⋰ & ⋮ \\ {\hat{g}}_{k}^{0} ( ω ) & ⋯ & {\hat{g}}_{k}^{i} ( ω )\end{matrix} ] [ \begin{matrix}{\hat{s}}_{0}^{0} ( ω ) & ⋯ & {\hat{s}}_{0}^{l} ( ω ) \\ ⋮ & ⋰ & ⋮ \\ {\hat{s}}_{i}^{0} ( ω ) & ⋯ & {\hat{s}}_{i}^{l} ( ω )\end{matrix} ] ,$$

where symbol \hat{ } indicates frequency domain

$$\hat{R} = \hat{G} \hat{S} ⇒ \hat{S} = {\hat{G}}^{- 1} \hat{R} ⇔ F ( {s}_{i}^{l} ) = {\sum }_{k} F ( {\tilde{g}}_{i}^{k} ) F ( {r}_{k}^{l} ) ,$$

where symbol ^{˜}represents an element of generalized inverse matrix

$${s}_{i}^{l} = {F}^{- 1} ( {\sum }_{k} F ( {\tilde{g}}_{i}^{k} ) F ( {r}_{k}^{l} ) ) \qquad ( eq . 206 )$$

Matrix G⁻¹ can be obtained as a result of calibration procedure as described in previous sections.

$${D}_{1} = {F}^{- 1} ( F ( {\tilde{g}}_{1}^{A} ) F ( {R}_{A} ) ) + {F}^{- 1} ( F ( {\tilde{g}}_{1}^{B} ) F ( {R}_{B} ) ) {=}^{{R}_{B} = const} {F}^{- 1} ( F ( {\tilde{g}}_{1}^{A} ) F ( {R}_{A} ) ) + {R}_{B} {\hat{\tilde{g}}}_{1 ( ω = 0 )}^{B}$$

$${D}_{2} = {F}^{- 1} ( F ( {\tilde{g}}_{2}^{A} ) F ( {R}_{A} ) ) + {F}^{- 1} ( F ( {\tilde{g}}_{2}^{B} ) F ( {R}_{B} ) ) {=}^{{R}_{B} = const} {F}^{- 1} ( F ( {\tilde{g}}_{2}^{A} ) F ( {R}_{A} ) ) + {R}_{B} {\hat{\tilde{g}}}_{2 ( ω = 0 )}^{B}$$

$$In common case of N channels \text{:}$$

$${D}_{i}^{k} ( t ) = {F}^{- 1} ( {\hat{\tilde{g}}}_{i}^{h} {\hat{r}}_{h} ) + {\sum }_{k \neq h} {R}_{k} {\hat{\tilde{g}}}_{i ( ω = 0 )}^{k} \qquad ( eq . 207 )$$

Similar equations can be obtained for case with R_{A}(t)=const, which shows practical approach of eliminating coupling between different plant outputs.

Matrix G⁻¹ in frequency domain can be stored as a frequency series and partitioned by row. Each row represents separate stimulus/driver channel and independent of other channels. In general case of N channels equations (eq.206) defines pre-computed time series for each stimulus/driver. These time series can be partitioned by a driver channel and a set of desired response functions.

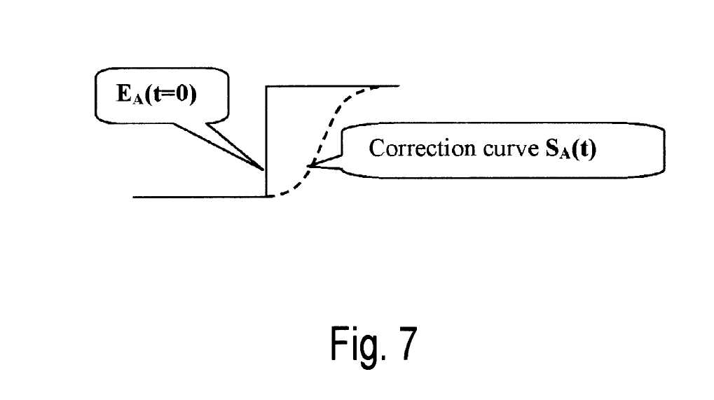

Such apparatus can efficiently operate in close-loop mode when readings from sensors contain disturbances from expected system state. Following demonstration shows a disturbance correction on cannel A. This is done just as an example and does not post limitation on the invention, the same approach equally applicable to any number of channels. At initial moment deviation of sensor A from nominal is −E_{A}. Obviously, it is impossible to compensate this deviation momentarily because it will violate causality principle in events propagation. To compensate the deviation some correction curve should be selected that has an ending value equal E_{A}. It is reasonable to select a smooth trajectory to eliminate undesirable disturbances as shown on FIG. 7 with trajectory amplitude constrained by E_{A}. Although multiple approaches for selection of optimal and nearly optimal trajectories were described in listed references for simplicity of this example a curve defined as ½E_{A}erfc(−t/b) is considered, where 2b is effective halve

$$F ( erf ( \frac{t}{b} ) ) = - \frac{ⅈ}{π k} exp ( - {( π kb )}^{2} ) ⇒ F ( erfc ( - \frac{t}{b} ) ) = - \frac{ⅈ}{π k} exp ( - {( π k b )}^{2} ) + δ ( k ) \\ ⇓ \\ {D}_{1} = {E}_{A} {F}^{- 1} ( F ( {\tilde{g}}_{1}^{A} ) \frac{- ⅈ}{2 π k} exp ( - {( π kb )}^{2} ) ) + \frac{1}{2} {E}_{A} {\hat{\tilde{g}}}_{1 ( ω = 0 )}^{A} + {R}_{B} {\hat{\tilde{g}}}_{1 ( ω = 0 )}^{B} \\ {D}_{2} = {E}_{A} {F}^{- 1} ( F ( {\tilde{g}}_{2}^{A} ) \frac{ⅈ}{2 π k} exp ( - {( π kb )}^{2} ) ) + \frac{1}{2} {E}_{A} {\hat{\tilde{g}}}_{2 ( ω = 0 )}^{A} + {R}_{B} {\hat{\tilde{g}}}_{2 ( ω = 0 )}^{B} \\ where 2 π k ≡ ω \qquad ( eq . 208 )$$

Note: erf(2)=0.9953, replacing erf(x) for |x|>2 with 1 and 1 accordingly will introduce 0.23% relative error. Such error is usually acceptable in majority of real-world applications. These equations also demonstrate that decrease in response time of feedback causes an increase in power utilization of drivers. Because of physical limitation the driving power is limited. The equation (eq.208) allows efficiently calculate the shortest achievable response time based on amplitude of the deviation and imposed constrains of current state of the extended plant.

These calculations can be made for complete envelope of imposed constraints. In example shown on FIG. 5 a lookup table for all specified nodes can be created.

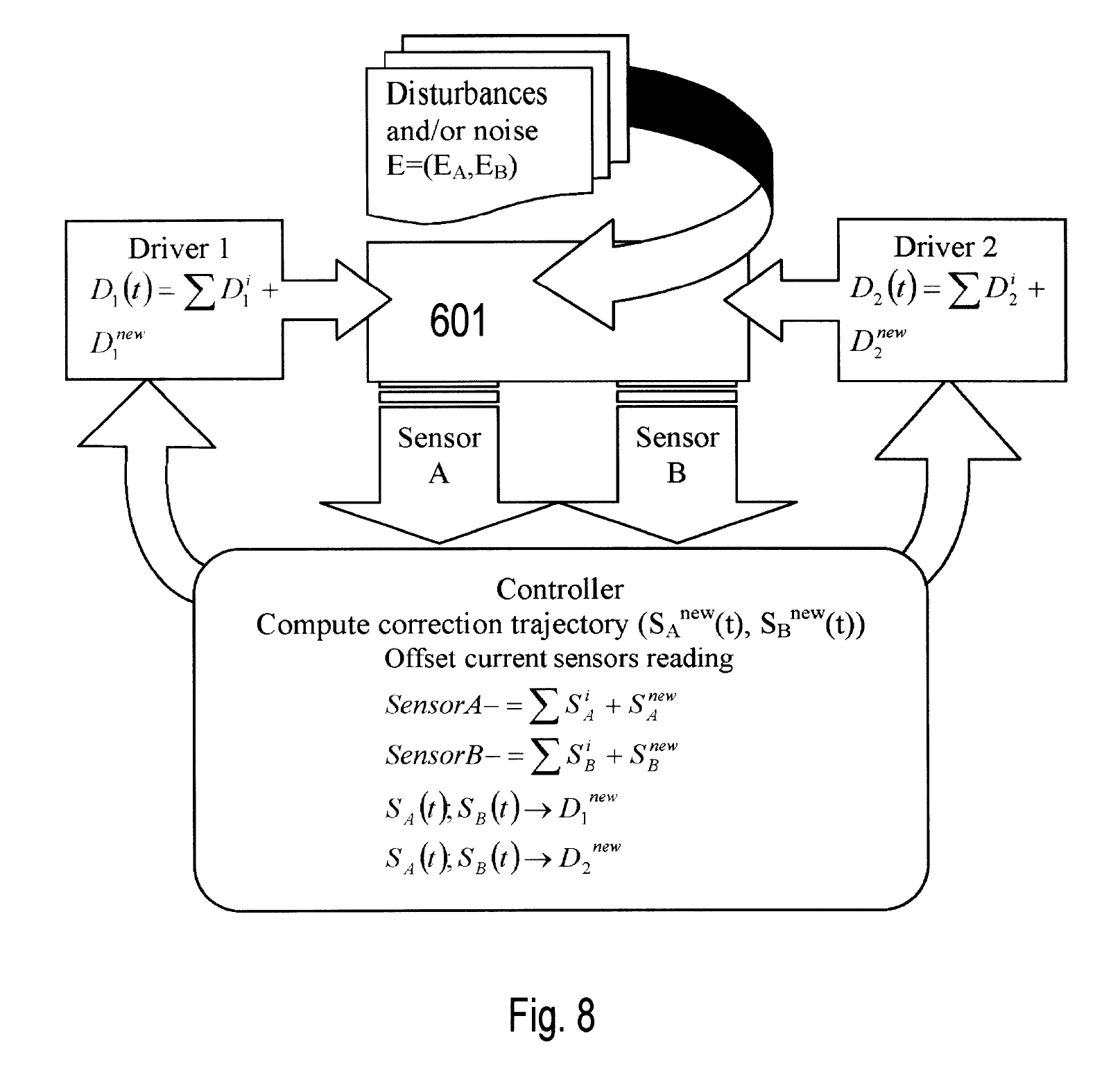

Complete block diagram of close-loop feedback operation is shown on FIG. 8. In response to the deviation driver functions are incremented by Dᵢ(t) and sensors readings are offset by Sⱼ(t). Implementation of controller algorithm may vary, and implement a set of optimal trajectories that satisfy different criteria (such as minimum peak power, fuel economy, fastest response, etc).

Example of Multithreaded MIMO Controller

This example illustrates construction of an apparatus that implements plurality of disclosed methods of this invention. This example refers to the apparatus as a controller. It will become obvious after reading this description that various physical implementation of the controller are possible due to wide availability and quick evolution of digital processing means and components for their creation. As an example controller with the same logical structure can be implemented using microcontroller, DSP, PDA, PC, and even discrete electronic components. Again it is obvious that some functional elements of the controller can be omitted at particular implementations to provide only minimal set of functionality required for specific solution. Again it is obvious that term multithreading can be applied to a single digital processing device as well as to plurality of processing devices (commonly referred as multiprocessing), and although there is a difference in implementation details in these two cases the methods of the invention can be equally implemented.

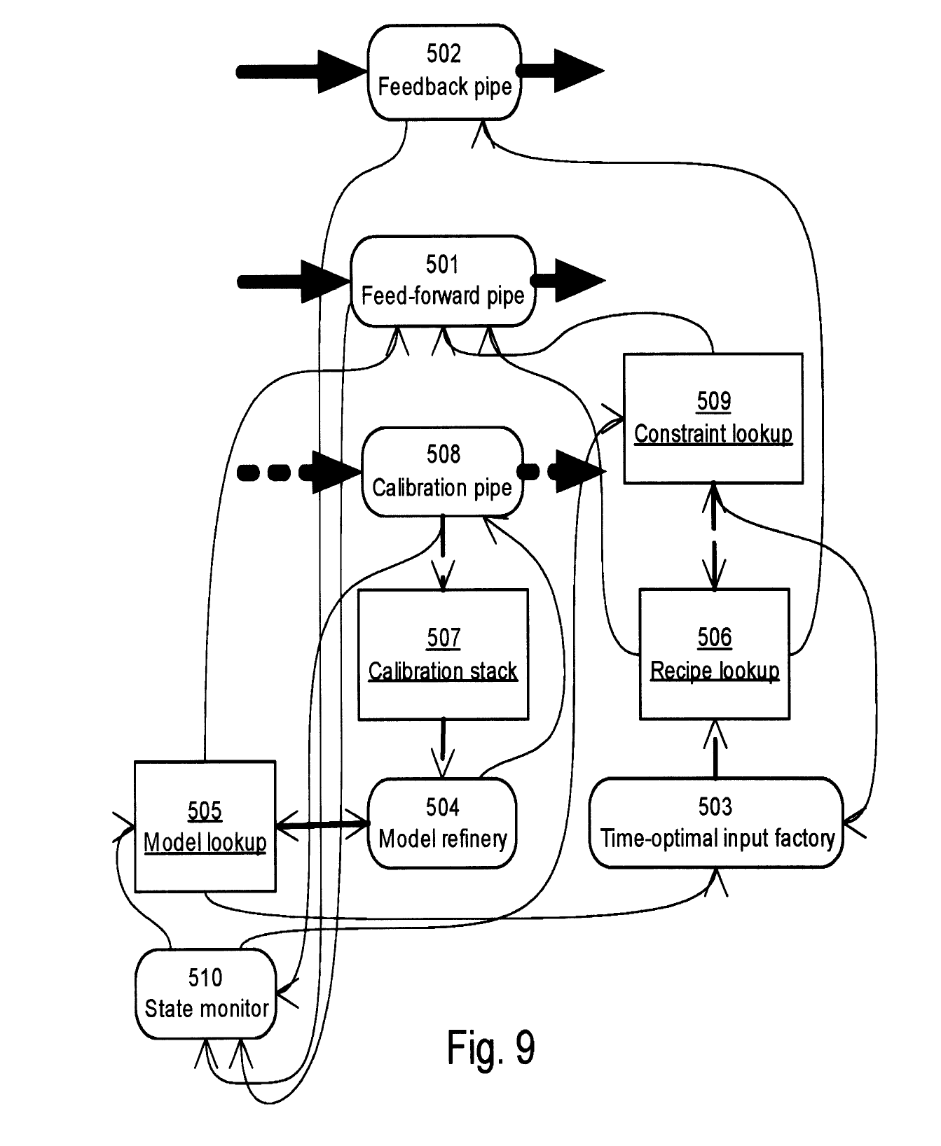

FIG. 9 shows high level organization of the controller. Two real-time threads 501 and 502 are responsible for carrying out primary controller functions. Each of feed-forward or feedback pipe can be incorporated into control solution specific to particular application. Feed-forward pipe 501 inputs receive control commands of desired plant outputs and produces plant control inputs. This pipe uses model data and current constraints. Some control commands may refer to use of specific time-optimal recipe. Note that time-optimal recipe could include various aspects of optimization, such as optimized for fuel efficiency, peak power consumption, etc. 501 requires minimum processing resources and depending on format of control commands and protocol can be implemented as a single execution thread. It is more practical to separate command processing portion of 501 into separate thread to allow processing of more sophisticated control protocols and commands.

Feedback pipe 502 inputs receives error signal that needs to be compensated. 502 uses recipes lookup 506 and scales down corresponding time-optimal control solution. Operations of feedback pipe 502 are very simple and require minimal processing resources and it is practical to implement it in single real-time thread.

Calibration pipe 508 operates in tie with calibration stack 507. Pipe 508 receives set of control input sequences from model refinery 504. These sequences are executed in real time through output of the 508 pipe. Inputs of 508 are acquired in real-time and pushed into FIFO stack 507 along with time stamp. Because of simplicity of operation of 508 its both input and output operations may be performed by single real-time thread.

In some implementations it is possible to allocate single execution thread for 501 output and 502 and 508 operations.

Model refinery 504 implements an algorithm executing system identification method of the invention. It uses Model lookup table 505 to store models and retrieve model that require update. It is not required for 504 to operate in real-time. Due to complex nature of its operations this module operates asynchronously and uses synchronization mechanisms when interacting with real-time threads.

Time-optimal input factory 503 uses model data 505 and constraint lookup 509 to discover time-optimal sets of control solutions. These sets are stored in recipe lookup table 506. Factory 503 performs its operation in asynchronous mode and uses synchronization mechanisms to when interacting wit real-time threads.

State monitor 510 monitors current state of output and input of the plant and matches it to one of existing models, which identifies current steady state of the plant. Operations of this model are time critical. Procedure of matching plant stimulus vector to matrix model can be quickly performed using SIMD processor instructions when vector has small dimensions (with today's mid range processors nearly real-time performance can be achieved for up to four dimensional vectors). Implementation algorithm for vectors of higher dimensions may restrict speed of module operations, but it will be sufficient for majority of applications that operates on sum megahertz rates.

Possible implementations of the controller include: integral controller that designed as single module containing all required elements; modular controller allows addition of new modules that expand its functions; and any intermediate implementation.

Modular controller has an ability to operate with reduced set of features/operations some of them are illustrated through the following examples: calibration, close-loop feedback, open-loop feed-forward control, etc.

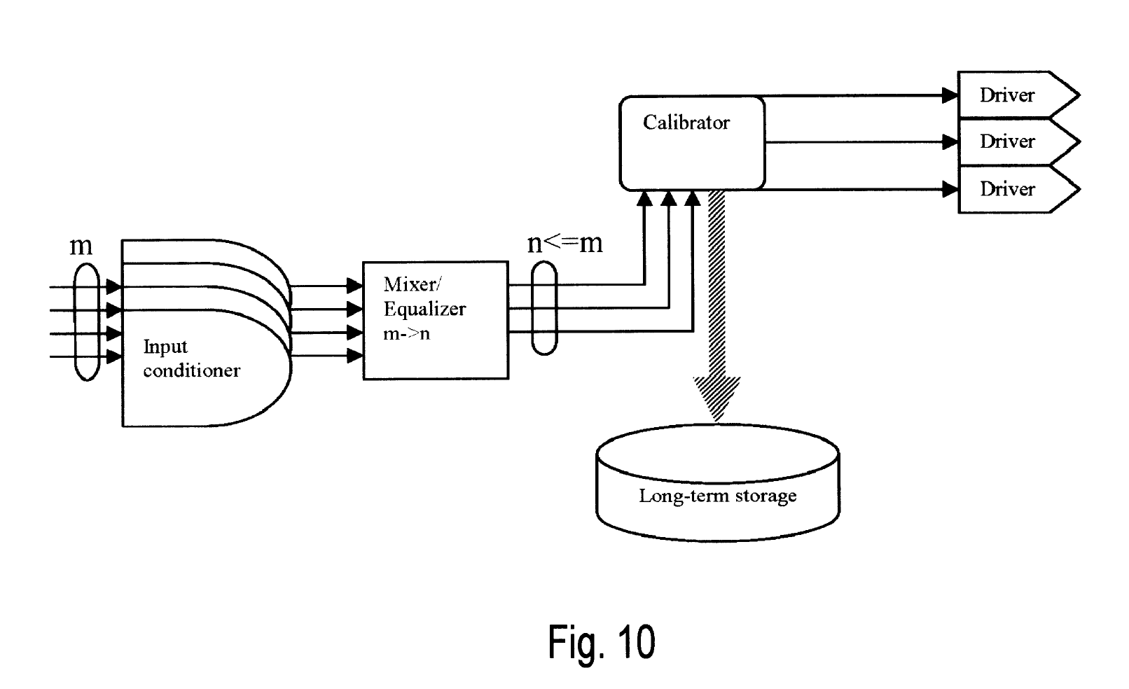

Block diagram of calibration module of modular controller is shown on FIG. 10. Referring to FIG. 9 calibrator module includes 504, 505, 507, and 508 and executes the calibration methods described in previous sections of this invention. During operation it provides real-time control signals for each driver or/and channel controller module and records real-time sensor data. Particular form of real-time signals and data depends on specific of particular implementation details and may be realized as, but not limited, analog signals, serial digital input, parallel digital input or/and any type of data with time information that is sufficient for synchronization. Calibrator may be implemented as completely automated module that operates with no human intervention, or may be as generic as personal computer with required set of peripheral devices. The essence of this invention does not depend on the form of practical implementation of this or any other module. The result of the calibrator operation a set of data described in previous sections. These data represent complete of incomplete models of the plant. The data recorded into long-term storage, which is required module for all features/operations of the controller.

Long-term storage contains data sets of partitioned time and/or frequency series described in previous sections of the invention. Each set is sufficient for operation of a single channel of feedback 502 feed-forward 501 modules. Depending on practical realization of the controller these data sets may be stored in single long-term storage module or may be distributed on several smaller modules. Physical media for these long-term storage modules may be, but not limited, magnetic, optical, ROM, RAM, EPROM, FLASH and any other type of memory devices.

Input conditioner represents a set of similar and/or heterogeneous devices that function as transducers conveying various real-world signals into electrical and/or digital form. An essential requirement for these transducers is fast conversion time.

Mixer/Equalizer converts all signals from transducers into digital or analog format. At the same time it may perform scaling of signal values to bring them to similar value range. This operation is not required if high precision arithmetic will be used in other digital modules, but it may help to increase computational precision. This module may mix different channels for various purposes (example: use redundant sensors to increase system reliability). Resulting number of output channels is always less or equal number of input channels, and exactly equal number of controller input channels.

Driver modules convert digital and/or electrical signals into various forms of real-world energy. They provide stimulus that change current state of the plant. The number of drivers is greater or equal to the number of control input channels of the plant, as example drivers may be redundant to increase reliability.

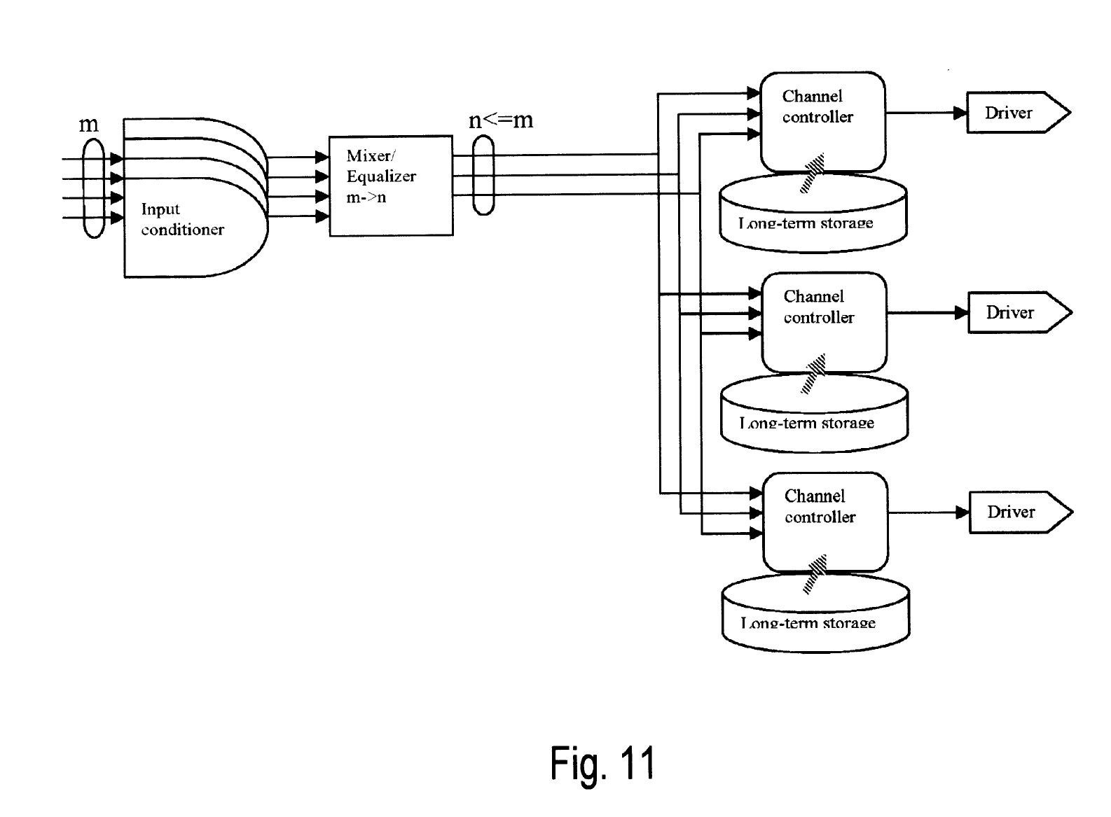

Close-loop feedback module is shown on FIG. 11. Its operations were described in previous sections. Referring to FIG. 9 this module encompasses operations of feedback pipe 502.

Signals from Mixer/Equalizer in digital or analog format are transmitted to channel controller. Channel controller uses data from long-term storage module containing recipe lookup table 506. Output signal from this module controls operation of the driver or a set of redundant and/or dependent drivers. The channel controller may use a user input that specifies a set of sensor reading or any other data that characterize the state of the plant. These data along with conditioned input data are used by state monitor 510.

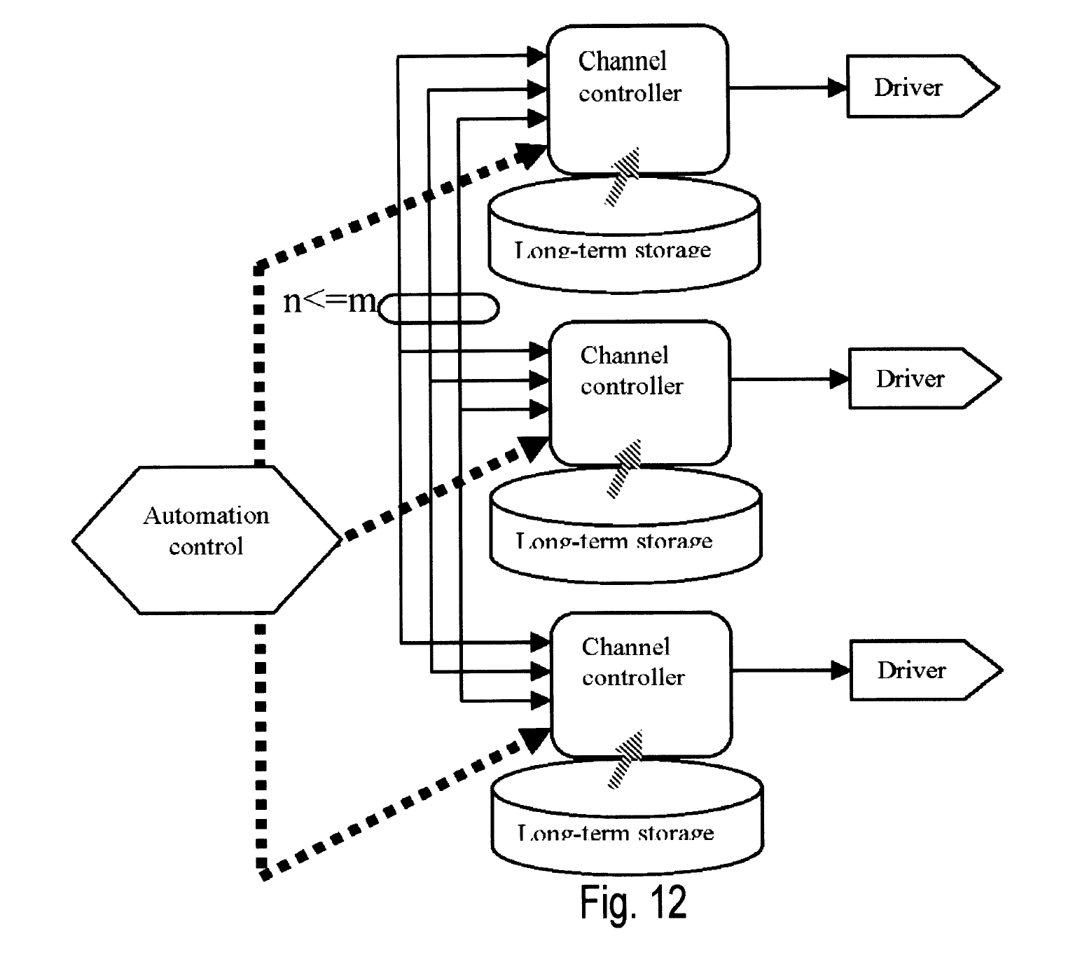

Block diagram of a open-loop feed-forward module is shown on FIG. 12. It operates according to description of feed-forward pipe 501 (refer to FIG. 9). The Automation control provides a set of command for channel controller that represent either optimal command stored in 506 lookup table or custom input trajectory that based on model data 505 and current constraints obtained from 509 lookup table. Channel controllers use data from long-term storage/s to determine output for driver in each control channel. The method that channel controllers use based on equation (eq.206). Creation of custom trajectory makes significant computational overhead for automation control when large number of channels is selected.

For Automation control that uses optimal set of trajectories all computations are done once by input factory 503 (refer to FIG. 9), and results are stored in log-term storage. At run-time simple lookup and scaling of pre-computed Dᵢ(t) is performed.

1. A method of multiple input multiple output system identification that utilizes dynamic construction of system response model and contains following steps:
recursive validation of the model accuracy on dynamically adjustable bands of allowable frequencies;
repetitive update of the model at dynamically selected bands of allowable frequencies.

2. A method of multiple input multiple output system identification that utilizes dynamic construction of system response model and contains following steps:
clustering analysis of the model during updates that identifies statistically significant changes in the model over specific bands of adjustable frequencies;
split of the model onto several models associated with individual clusters and invalidation of bands of allowable frequencies on which clustering was detected;

3. A method of multiple input multiple output system identification that utilizes dynamic refinement or revalidation of system response model and is invoked during normal operations of said system and said method contains steps of claims 1 or 2.

4. A method of multiple input multiple output system identification that utilizes dynamic construction of system response model and said model is accounting for possible hysteresis in the system and identification steps involve repetitive use of control inputs that shapes are defined as a functions with wide-band frequency spectrum and either infinitely piecewise smooth or having k piecewise continuous derivatives.

5. A method of multiple input multiple output system identification that utilizes dynamic construction of system response model and said model is accounting for possible hysteresis in the system and uses method of claim 4 and said method contains steps of claims 1 or 2 or 3.

6. A method of identification of multiple input multiple output system that dynamically constructs system model which incorporates input-input dependency and output-output dependency and at some state can be represented in matrix form as
$$g ( t ) = [ \begin{matrix}{g}_{0} & {( I - {g}_{0} )}^{- 1} {g}_{1} \\ {( I - {g}_{3} )}^{- 1} {g}_{2} & {g}_{3}\end{matrix} ]$$
, where g₀ and g₃ are square matrixes.

7. A method of identification of a steady state among multiple possible steady states of multiple input multiple output system that invokes the model of the system according to claim 6 and includes step of matching vector of function or vector of time series to one of existing system response matrix, wherein said vector composed of inputs and outputs of the system and said matrix is structured according to claim 6 and matching process involves convolution or product of said matrix an vector.

8. A method of open-loop or close-loop feedback control of multiple input multiple output system that utilizes dynamically constructed or dynamically refined model that comprises plurality of linear models and wherein said linear models have identified associations with trajectory of changes of control inputs of said system and direction of following said trajectory, and wherein said dynamic construction or refinement is in accordance with claim 4.

9. A method of open-loop or close-loop feedback control of multiple input multiple output system that utilizes dynamically constructed optimal control solutions for control inputs of said system and wherein each said solution is created for specific steady state of the system and for specific values of constraints imposed on the system and said control and said method includes following steps:
a priory creation of plurality of optimal solutions for control inputs;
real-time lookup of optimal solution based on current steady state of the system and closest match of current functions of inputs and outputs of said system to values of a priory selected constraints and where said lookup may be accelerated by means of a priory indexing or ordering of said constraints.

10. A digital algorithm implementing method of claim 1 that realized as high-level software language or low level binary code and aided for execution on two ore more digital processing devices.

11. A digital algorithm implementing method of claim 2 that realized as high-level software language or low level binary code and aided for execution on two ore more digital processing devices.

12. A digital algorithm implementing method of claim 4 that realized as high-level software language or low level binary code and aided for execution on two ore more digital processing devices.

13. A digital algorithm implementing method of claim 6 that realized as high-level software language or low level binary code and aided for execution on two ore more digital processing devices.

14. An digital algorithm implementing method of claim 7 that realized as high-level software language or low level binary code and aided for execution on two or more digital processing devices.

15. An digital algorithm implementing method of claim 8 that realized as high-level software language or low level binary code and aided for execution on two or more digital processing devices.

16. An digital algorithm implementing method of claim 9 that realized as high-level software language or low level binary code and aided for execution on two or more digital processing devices.

17. [claim Reference] [claim Reference] [claim Reference] [claim Reference] [claim Reference] [claim Reference] [claim Reference] [claim Reference] [claim Reference]An apparatus incorporating only single digital processing device and at least one method of this invention and said apparatus operating as close-loop feedback controller only.

18. [claim Reference] [claim Reference] [claim Reference] [claim Reference] [claim Reference] [claim Reference] [claim Reference] [claim Reference] [claim Reference] An apparatus incorporating only single digital processing device and at least one method of this invention and said apparatus operating as open-loop or feed-forward controller only.

19. [claim Reference] [claim Reference] [claim Reference] [claim Reference] [claim Reference] [claim Reference] [claim Reference] [claim Reference] [claim Reference] An apparatus incorporating multiple single digital processing devices and at least one method of this invention and said apparatus operating as close-loop feedback controller only.

20. [claim Reference] [claim Reference] [claim Reference] [claim Reference] [claim Reference] [claim Reference] [claim Reference] [claim Reference] [claim Reference]An apparatus incorporating multiple single digital processing devices and at least one method of this invention and said apparatus operating as open-loop or feed-forward controller only.
